(19) United States
(12) Patent Application Publication
(10) Pub. No.: US 2002/0167258 A1
(43) Pub. Date: Nov. 14, 2002

(54) Thermionic emitter

(76) Inventors: Ronald Dittrich, Forchheim (DE); Erich Hell, Erlangen (DE); Markus Schild, Herzogenaurach (DE)

Correspondence Address: SCHIFF HARDIN & WAITE, Patent Department, 6600 Sears Tower, 233 South Wacker Drive, Chicago, IL, 60606, US

(21) Appl. No.: 10/113,280

(22) Filed: Apr. 1, 2002

(30) Foreign Application Priority Data
Mar. 30, 2001 (DE) 10115901.3

(51) Int. Cl. H01K 1/04; H01J 19/06

(52) U.S. Cl. 313/346 DC; 313/346 R

(57) ABSTRACT

A thermionic emitter for use in an X-ray tube with a rotating cathode, particularly in rotating bulb X-ray tubes, is composed of an alloy of a refractory metal, such as tungsten, with an additive of at least 20 ppm potassium. This emitter material avoids deterioration of the emitter due to grain creep.

### BACKGROUND OF THE INVENTION

1. Field of the Invention

The present invention is directed to a thermionic emitter for use in an X-ray tube having a rotating cathode.

2. Description of the Prior Art

Thermionic emitters are preferably used in radiology in rotating bulb tubes. The emitters therein are usually implemented as flat emitters and are composed of a thin tungsten sheet that is fashioned in a serpentine configuration. Such an emitter is disclosed in greater detail, for example, by German OS 100 16 125.

In addition to the static forces (gravitation), strong dynamic forces (centrifugal forces) occur at the high rotation speeds (up to 10,000 rpm) with which the X-ray tube, and thus the cathode with the emitter, are operated. Given employment of tungsten or similarly refractory metals, these stresses lead to a pronounced grain creep. This effect, after a longer operating time of the tubes, causes deformations to occur at the emitter that can ultimately lead to a destruction of the emitter. This disadvantage is especially evident in the aforementioned flat emitters with a serpentine configuration since these, due to their shape, are less stable in view of radially acting forces.

Stability with respect to the radially acting forces could in fact be increased with a different shaping and support of the emitter. Such measures, however, would in turn produce certain limitations with respect to other design parameters such as emission area, thickness and diameter of the emitter, as well as temperature distribution within the emitter.

### SUMMARY OF THE INVENTION

An object of the present invention is to provide thermionic emitter of the type initially described wherein such limitations need not be accepted.

The above object is achieved in accordance with the principles of the present invention in a thermionic emitter for use in an X-ray tube with rotating cathode wherein the emitter is composed of an alloy of a refractory material with an additive of at least 20 ppm potassium.

The refractory material may be tungsten, for example. The emitter may be a flat emitter, and may have a serpentine configuration.

### DESCRIPTION OF THE PREFERRED EMBODIMENTS

The thermionic emitter of the invention is for use in an X-ray tube with a rotating cathode, such as a rotating bulb X-ray tube wherein conventional employed emitters exhibit grain creep and therefore, due to the high rotational speeds in such X-ray tubes, are subject to deterioration leading to failure.

The present invention is based on the recognition that grain creep can be largely suppressed by employing an allow composed of a refractory metal with an additive of potassium. The potassium forms extremely minute bubbles at the grain boundaries that represent a barrier for further grain boundary diffusions and thus highly suppress a creep of the grains relative to one another.

The service life of such an emitter can be significantly lengthened given the same grain size. Tests have shown that the service life of an emitter can be lengthened four-fold with the inventively proposed potassium doping compared to an emitter composed of traditional material.

The proportion of potassium advantageously lies in the range from about 30 through 500 ppm (parts per million).

The employment of a tungsten alloy with said potassium additive is especially advantageous.

The potassium-doped tungsten alloy yields particular advantages in combination with an emitter that is fashioned as flat emitter. The emitter, moreover, may have a serpentine configuration.

Although modifications and changes may be suggested by those skilled in the art, it is in the intention of the inventors to embody within the patent warranted hereon all changes and modifications as reasonably and properly come within the scope of their contribution to the art.

We claim as our invention:

1. A thermionic emitter for use in an X-ray tube having a rotating cathode, said thermionic emitter being comprised of an alloy of a refractory metal with an additive of at least 20 ppm potassium.

2. A thermionic emitter as claimed in claim 1 wherein said potassium additive is in a range between 30 and 500 ppm.

3. A thermionic emitter as claimed in claim 1 wherein said potassium additive is 70 ppm.

4. A thermionic emitter as claimed in claim 1 wherein said refractory metal is tungsten.

5. A thermionic emitter as claimed in claim 1 wherein said emitter is a flat emitter.

6. A thermionic emitter as claimed in claim 5 wherein said flat emitter has a serpentine configuration.
